(19) United States
(12) Patent Application Publication
(10) Pub. No.: US 2013/0100015 A1
(43) Pub. Date: Apr. 25, 2013

(54) OPTICAL INPUT DEVICES

(71) Applicant: Kenneth Edward Salsman, Pleasanton, CA (US)

(72) Inventor: Kenneth Edward Salsman, Pleasanton, CA (US)

(21) Appl. No.: 13/660,939

(22) Filed: Oct. 25, 2012

Related U.S. Application Data
(60) Provisional application No. 61/551,289, filed on Oct. 25, 2011.

(51) Int. Cl. G06F 3/01

(52) U.S. Cl. 345/156

(57) ABSTRACT

A system may be provided that includes computing equipment and an optical input accessory. The computing equipment may include an imaging system, storage and processing circuitry, a display, communications circuitry, and input-output devices. The optical input accessory may include one or more light sources and optical markers representing instrument components for multiple instruments. The optical markers may be printed, molded or otherwise formed on a surface of a housing structure. The light sources may each emit a particular type of light. The computing equipment may use the imaging system to track the relative locations of the light sources and to continuously capture images of the optical markers and of user input objects. The computing equipment may generate audio, video or other output based on user input data generated in response to detected changes in position of the user input object with respect to the optical markers in the images.

This application claims the benefit of provisional patent application No. 61/551,289, filed Oct. 25, 2011, which is hereby incorporated by reference herein in its entirety.

### BACKGROUND

This relates generally to systems that gather user input and, more particularly, to systems with optical input devices for gathering user input.

Electronic devices often have input-output components. For example, an electronic device may contain an output component such as a display or status indicator light for providing visual output to a user or may have a speaker or buzzer for providing audible output to a user. Input components such as electrical switches may be used to form keyboards, dedicated buttons, and other electromechanical input devices.

It may be desirable in some electronic devices to use other types of input devices. For example, it may be desirable to use optical input devices that can accept input in ways that would be difficult or impossible using electromechanical input devices based on switches.

### BRIEF DESCRIPTION OF THE DRAWINGS

FIG. 1 is a diagram of an illustrative system of the type that may include an optical input device in accordance with an embodiment of the present invention.

FIG. 2 is a perspective view of an illustrative optical input device in accordance with an embodiment of the present invention.

FIG. 3 is a diagram of illustrative light intensity modulations that can be used to generate intensity-modulated light that is specific to a given light source in accordance with an embodiment of the present invention.

FIG. 4 is diagram showing how virtual characters on a system display may be controlled based on captured images of user actions with respect to one or more optical input devices in accordance with an embodiment of the present invention.

FIG. 5 is a flow chart of illustrative steps that may be used in operating a system having an optical input device in accordance with an embodiment of the present invention.

FIG. 6 is a block diagram of a processor system employing the embodiment of FIG. 1 in accordance with an embodiment of the present invention.

### DETAILED DESCRIPTION

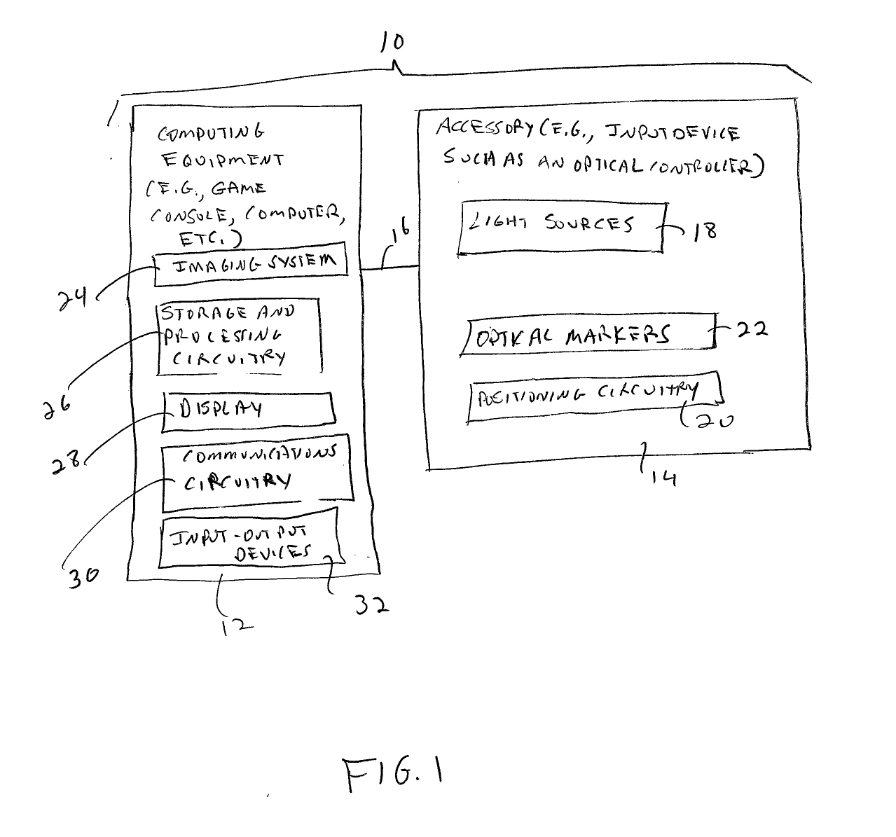

An illustrative system in which an optical input device may be used is shown in FIG. 1. As shown in FIG. 1, system 10 may include an optical input device (optical controller) such as accessory 14. Accessory 14 may, for example, be a game controller such as a poly-instrument that includes one or more musical instruments such as a keyboard, a guitar, drums, etc.

Accessory 14 may optionally be connected to external electronic equipment 12 such as a computer or game console. Accessory 14 may, for example, be coupled to equipment 12 using communications path 16. Path 16 may be a wireless path or a wired path (e.g., a Universal Serial Bus path). However, this is merely illustrative. If desired, input from accessory 14 may be provided to equipment 12 using images of accessory 14 captured using, for example, imaging system 24 of equipment 12.

Input such as user input from accessory 14 may be used to control equipment 12. For example, user input from accessory 14 may allow a user to play a game on computing equipment 12 or may allow a user to supply information to other applications (e.g., a music creation application, etc.).

Optical input device 14 may contain one or more light sources 18 and visually recognizable markings such as optical markers 22 (e.g., painted, drawn, printed, molded or other optical markers such as images of piano keys, guitar strings, drum pads, gaming control buttons or other visual representations of user input structures). If desired, device 14 may include positioning circuitry 20 such as one or more accelerometers. Light sources 18 may be lasers, light-emitting diodes or other light sources that emit light that is later detected by a light sensing component such as imaging system 24 of computing equipment 12.

A user of system 10 may supply input to system 10 using optical input device 14 by moving a finger or other object with respect to optical markers 22. For example, a user may strike an image of a piano key on a surface of accessory 14 with a given velocity and impulse. Imaging system 24 may capture high-speed, high-resolution images of the user motion with respect to the markers. Control circuitry such as storage and processing circuitry 26 may be used to extract user input data from the images of the user motions and the optical markers. Storage and processing circuitry 26 may include a microprocessor, application-specific integrated circuits, memory circuits and other storage, etc.

Equipment 12 may include input-output devices 32 such as a speaker, light sources, a light-emitting diode or other status indicator, etc. Equipment 12 may include a display such as display 28. Display 28 may be an integral portion of equipment 12 (e.g., an integrated liquid crystal display, plasma display or an integrated display based on other display technologies) or may be a separate monitor that is coupled to equipment 12.

Display 28 and/or input-output devices 32 may be operated by circuitry 26 based on user input obtained from accessory 14. For example, display 28 may be used to display a character that mimics user actions that are performed while holding accessory 14. Equipment 12 may include communications circuitry 30 (e.g., wireless local area network circuitry, cellular network communications circuitry, etc). Communications circuitry 30 may be used to allow user input gathered using accessory 14 to be transmitted to other users in other locations and/or to allow other user input from other users in other locations to be combined with user input from accessory 14 using circuitry 26. For example, multiple users in remote locations, each having a poly-instrument such as accessory 14, may be able to play a song together using combined input from each poly-instrument.

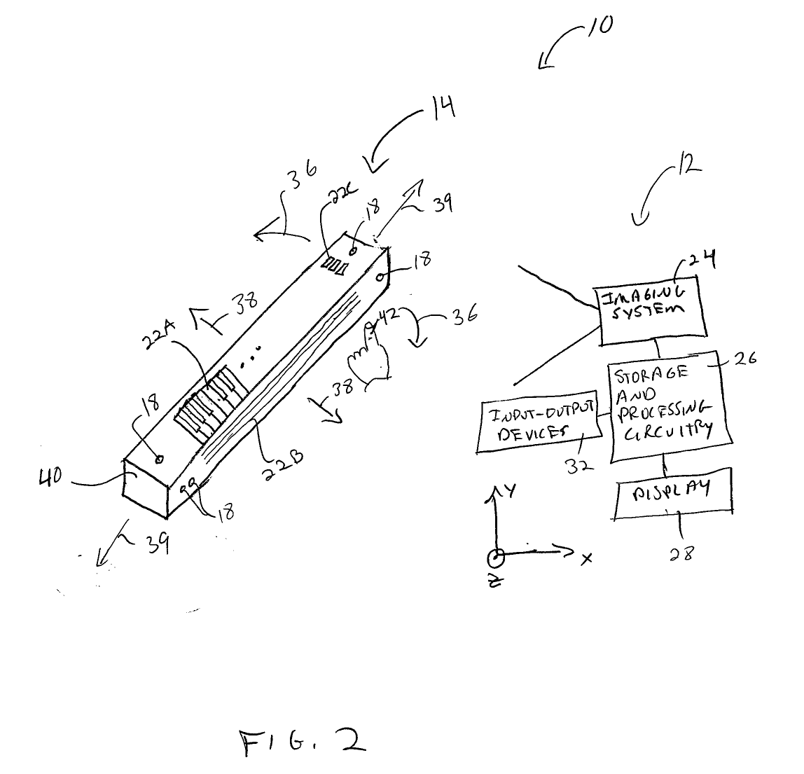

An illustrative configuration that may be used for optical input device 14 is shown in FIG. 2. As shown in FIG. 2, optical input device 14 may include a housing structure such as housing 40, optical markers 22 on housing 40 and light sources 18 mounted on housing 40. In the example of FIG. 2, accessory 14 has a rectilinear shape. However, this is merely illustrative. Other shapes and sizes of may be used for optical input device 14, if desired.

As shown in FIG. 2, accessory 14 may be implemented as poly-instrument having optical markers 22 that indicate input components for multiple instruments. Optical markers 22 may include optical markers 22A resembling piano keys (e.g., visual representations of piano keys), optical markers 22B resembling guitar strings (e.g., visual representations of guitar strings), or other instrument related optical markers (e.g., visual representations of drum pads, saxophone keys, trumpet keys, clarinet keys, or other instrument components). Optical markers 22 may also include other input key markers such as optical markers 22C that are visual representations of buttons such as power buttons, volume buttons, or other buttons for operating computing equipment 12.

Optical markers 22 may be painted, drawn, printed, molded or otherwise formed on housing 40. If desired, optical markers 22 may be formed on moving members mounted in housing 40 to give a user of accessory 14 the physical sensation of operating a button, an instrument key, instrument string or other component that is commonly formed on a moving part.

Imaging system 24 may be used to capture images of a poly-instrument such as accessory 14 of FIG. 2 during operation of system 10. Imaging system 24 may include one or more image sensors each having one or more arrays of image pixels such as complementary metal oxide semiconductor (CMOS) image pixels or other image pixels for capturing images. Imaging system 24 may be used to capture images of poly-instrument 14 and a user input device 42 such as a user's finger. Images of user input device 42 and optical markers 22 may be provided to storage and processing circuitry 26. Circuitry 26 may generate user input data based on the provided images.

User input data may be generated by determining positions of user input devices such as device 42 with respect to optical markers 22 in each image and determining motions of the user input devices based on changes in the positions of the user input devices from image to image.

For example, as a user moves their fingers against markers 22A in a piano playing motion, the positions of each finger will change with respect to markers 22A from image to image. Based on these changes, circuitry 26 may generate user input data and instruct display 28 and input-output devices 32 to take suitable action based on the user input data (e.g., to play piano sounds and display video content in accordance with the motions of the user).

Light sources 18 may be used to emit light that is received by imaging system 24. Light sources 18 may be visible light sources and/or infrared light sources. Imaging system 24 may gather position and orientation data related to the position and orientation of accessory 14 using the captured light from light sources 18. Imaging system 24 may capture images of light sources 18 using an image sensor that is also used to capture images of optical markers 22 and user input devices 42 or imaging system 24 may include additional light sensors such as infrared light sensors that respond to and track light from light sources 18.

Imaging system 24 and circuitry 26 may be used to determine the position and orientation of accessory 14 using light from light sources 18. User input may be generated by moving accessory 14. For example, a user may move accessory 14 back and forth as indicated by arrows 39 or as indicated by arrows 38, a user may rotate accessory 14 as indicated by arrows 36 or a user may twist, turn, rotate or otherwise move accessory 14 in the x, y or z directions of FIG. 2. Imaging system 24 may track these or other types of motions by tracking the relative positions of light sources 18.

Circuitry 26 may generate user input data that is used to operate system 10 based on the tracked positions of light sources 18. For example, circuitry 26 may raise or lower the volume of music generated by devices 32 in response to detecting rotational motion of the type indicated by arrows 36. Circuitry 26 may add effects such as reverberations or pitch variations in response to detecting back and forth motion of the type indicated by arrows 38 and/or 39. Circuitry 26 may generate a first type of effect when accessory 14 is moved in a first direction and a second, different type of effect when accessory 14 is moved in second, different direction such as an orthogonal direction.

Each light source 18 may emit a type of light that is particular to that light source. Imaging system 24 and circuitry 26 may identify a particular light source 18 by identifying the particular type of light associated with that light source and determining the relative positions of the identified light sources. Imaging system 24 and circuitry 26 may generate position and orientation data that represents the position and orientation of accessory 14 using the determined positions of light sources 18.

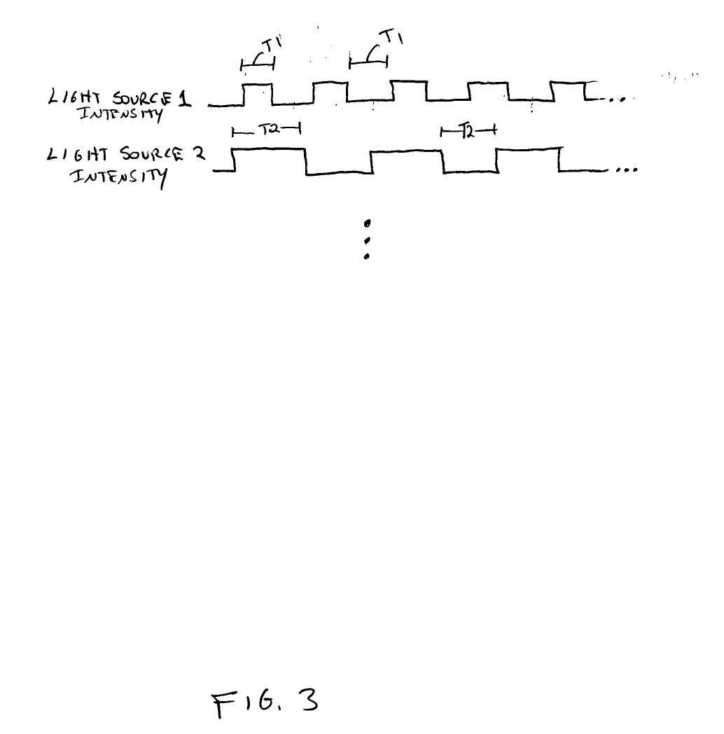

Light sources 18 may each emit a particular frequency of light or may emit light that is modulated at a particular modulation frequency that is different from that of other light sources 18 as shown in FIG. 3. In the example of FIG. 3, a first light source may be modulated so that the intensity of that light source is high for a time T1 and transitions to low for an additional time T1 while a second light source is modulated so that the intensity of that light source is high for a time T2 and transitions to low for an additional time T2. Other light sources may be modulated from high to low for different amounts of time. Each light source may be identified by computing equipment 12 by identifying the modulating signature of that light source. However, this is merely illustrative. If desired, light sources 18 on accessory 14 may be identified based on the color of light emitted by that light source or using other properties of the light emitted by that light source.

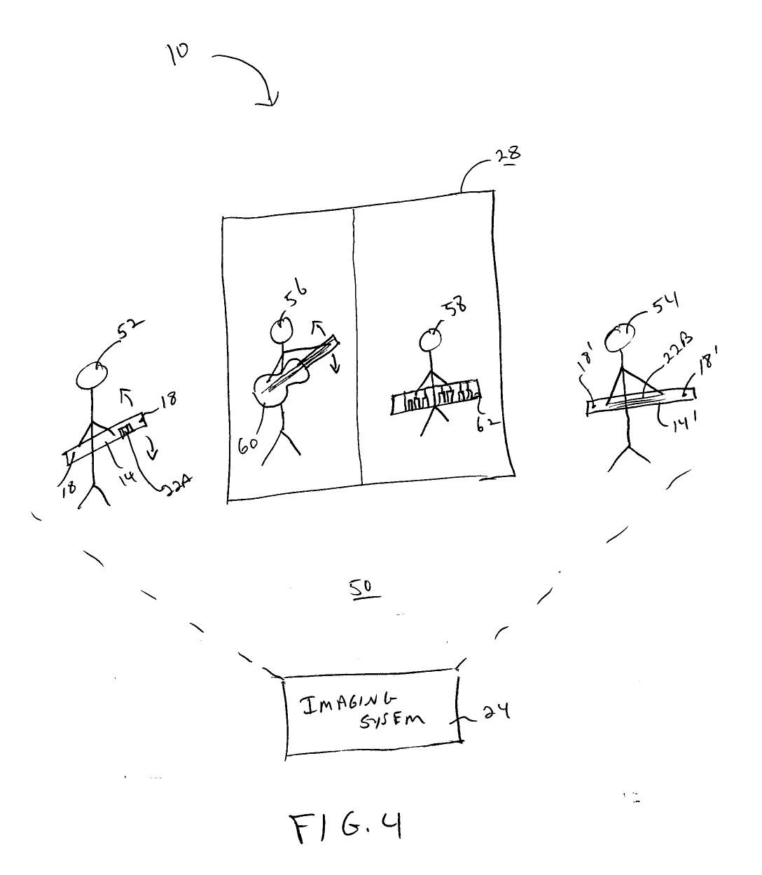

FIG. 4 is a diagram showing how one or more users may use one or more accessories 14 to operate system 10. Imaging system 24 may capture images of a field-of-view 50 that includes one or more poly-instruments such accessory 14 and accessory 14′. A first user such as user 52 may hold accessory 14 so that a first set of light sources 18 is visible to imaging system 24. Light from light sources 18 may be used to identify the type of instrument (e.g., a piano keyboard) to be used by user 52 and to identify the current position of accessory 14. System 10 (e.g., circuitry 26, not shown) may be used to generate a virtual character 58 on display 28 holding a piano keyboard 62 (or sitting at a piano) in a position that corresponds to the orientation of accessory 14. A second user such as user 54 may hold accessory 14′ so that a second set of light sources 18′ is visible to imaging system 24. Light from light sources 18′ may used to identify the type of instrument (e.g., an electric or acoustic guitar) to be used by user 54 and to identify the current position of accessory 14′. System 10 (e.g., circuitry 26, not shown) may be used to generate a virtual character 56 on display 28 holding a guitar 60 in a position that corresponds to the orientation of accessory 14′.

During operation of system 10, virtual characters 56 and 58 may move and play instruments 60 and 62 in response to captured images of user motions with respect to markers 22A and 22B and accessory motions tracked using light sources 18 and 18′. In the example of FIG. 4, two users at a common location control system 10 and two corresponding virtual users are displayed on display 28. However, this is merely illustrative. Any number of users using any number of accessories at any number of locations may cooperatively control system 10 using respective accessories.

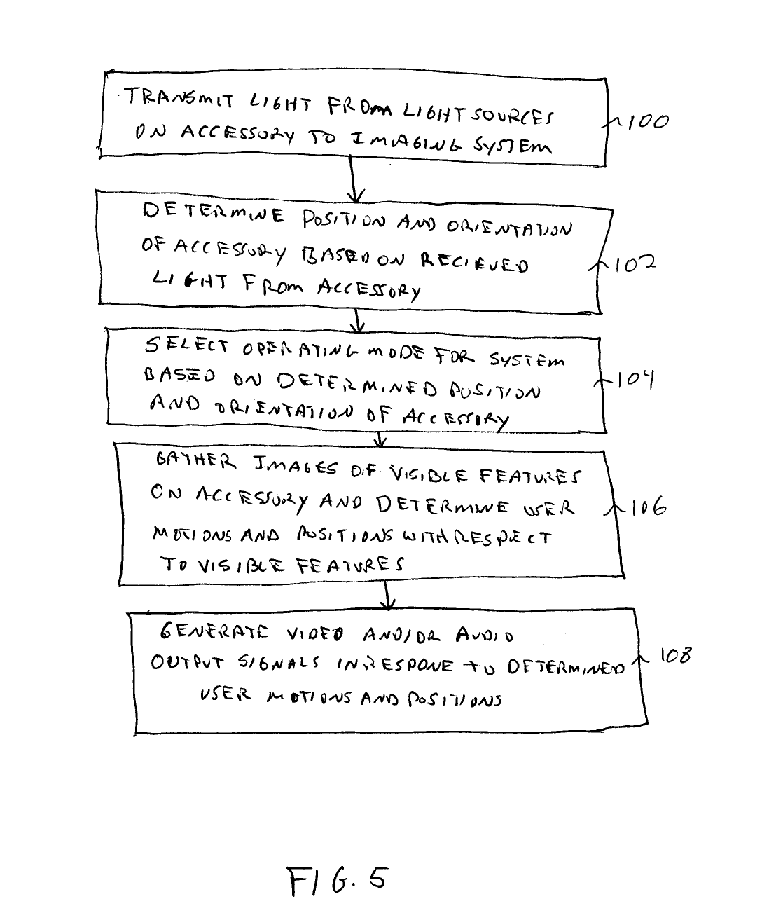

Illustrative steps that may be used in controlling a system such as system 10 having accessories such as optical input devices 14 are shown in FIG. 5.

At step 100, light may be transmitted from one or more light sources on a system accessory such as a poly-instrument (e.g., accessory 14) to an imaging system.

At step 102, the position and orientation of the accessory may be determined based on the received light from the accessory. Determining the position and orientation of the accessory may include identifying each light source based on the type of light received from that light source, determining the relative positions of the light sources using the light source identifications, and determining the position and orientation of the accessory using the determined relative positions of the light sources.

At step 104, an operating mode for the system may be selected based on the determined position and orientation of the accessory. For example, system 10 may be operated in a first mode (e.g., a piano player mode) if a first surface of the accessory is facing the imaging system or a second mode (e.g., a guitar player mode) if a second face of the accessory is facing the imaging system. The system may determine which face of the accessory is facing the system using light source identifications (i.e., which set of light sources is emitting light into the imaging system) or using images of the face of the accessory (e.g., by identifying piano key optical markers or guitar string optical markers in images of the accessory.

At step 106, images of visible features such as optical markers on the accessory (and of user input devices) may be gathered. User motions and positions with respect to the visible features may be determined using the gathered images of the visible features and the user input devices.

At step 108, video and/or audio output signals may be generated in response to the determined user motions and positions. Generating audio output signals in response to the determined user motions and positions may include generating instrument sounds corresponding to user motions with respect to instrument component optical markers. Generating video signals in response to the determined user motions and positions may include displaying video images of a virtual user playing an instrument using motions corresponding to user motions with respect to instrument component optical markers.

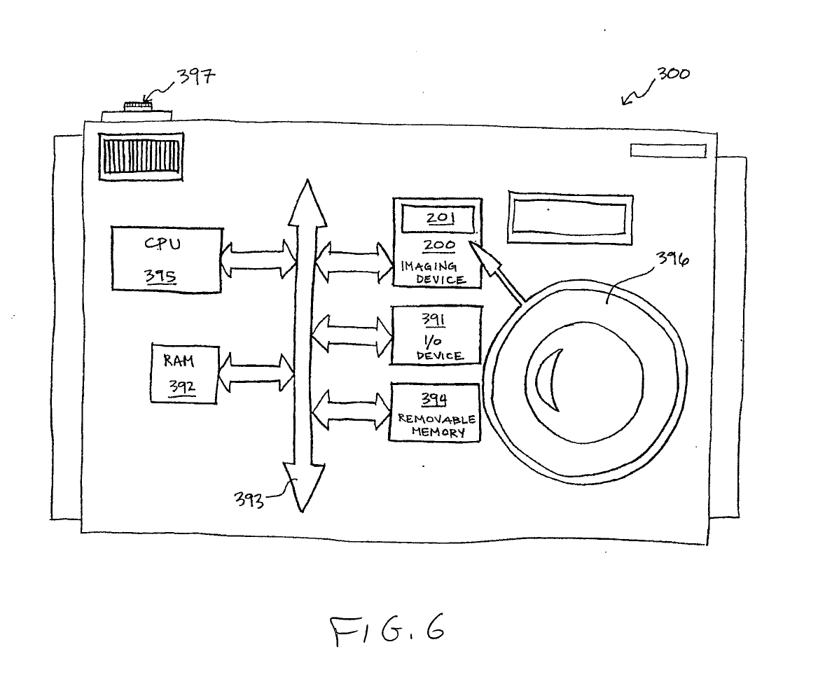

FIG. 6 shows, in simplified form, a typical processor system 300, such as computing equipment 10 of FIG. 1. Processor system 300 is exemplary of a system having digital circuits that could include imaging device 200 (e.g., an image sensor or other light sensor in imaging system 24). Without being limiting, such a system could include a computer system, still or video camera system, scanner, machine vision, vehicle navigation, video phone, surveillance system, auto focus system, star tracker system, motion detection system, image stabilization system, video gaming system, video overlay system, and other systems employing an imaging device.

Processor system 300, which may be a digital still or video camera system, may include a lens such as lens 396 for focusing an image onto a pixel array such as pixel array 201 when shutter release button 397 is pressed. Processor system 300 may include a central processing unit such as central processing unit (CPU) 395. CPU 395 may be a microprocessor that controls camera functions and one or more image flow functions and communicates with one or more input/output (I/O) devices 391 over a bus such as bus 393. Imaging device 200 may also communicate with CPU 395 over bus 393. System 300 may include random access memory (RAM) 392 and removable memory 394. Removable memory 394 may include flash memory that communicates with CPU 395 over bus 393. Imaging device 200 may be combined with CPU 395, with or without memory storage, on a single integrated circuit or on a different chip. Although bus 393 is illustrated as a single bus, it may be one or more buses or bridges or other communication paths used to interconnect the system components.

Various embodiments have been described illustrating a system having computing equipment and an optical input accessory. The computing equipment may include an imaging system, storage and processing circuitry, a display, communications circuitry, and input-output devices such as keyboards and speakers.

The optical input accessory may be a controller such as poly-instrument having optical markers representing input components such as instrument components for multiple instruments. A poly-instrument may include optical markers corresponding to piano keys, drum pads, guitar strings, or other instrument components. The optical markers may be printed, molded or otherwise formed on a surface of a housing structure. The optical input accessory may include one or more light sources and, if desired, positioning circuitry (e.g., one or more accelerometers).

The light sources may be located at extreme ends of an elongated accessory and may each emit a particular type of light. The computing equipment may track the relative locations of the light sources using the imaging system. The computing equipment may use the imaging system to continuously capture images of a user input component such as a user's finger and of the optical markers. The computing system may generate audio, video or other output based on monitoring images of the motion of the user input object with respect to the optical markers on the accessory.

The foregoing is merely illustrative of the principles of this invention which can be practiced in other embodiments.

What is claimed is:

1. A system, comprising:
an imaging system;
control circuitry; and
an optical input accessory a having a plurality of optical markers, wherein the imaging system is configured to capture images of the optical markers on the optical input accessory and wherein the control circuitry is configured to operate the system based on the captured images of the optical markers.

2. The system defined in claim 1 wherein the optical input accessory comprises a poly-instrument and wherein the optical markers comprises visual representations of instrument components on the poly-instrument.

3. The system defined in claim 2 wherein the optical input accessory comprises a housing structure and wherein the optical markers are printed on a surface of the housing structure.

4. The system defined in claim 3, further comprising a display, wherein the control circuitry is configured to operate the system based on the captured images of the optical markers by operating the display based on the captured images of the optical markers.

5. The system defined in claim 4, further comprising at least one speaker, wherein the control circuitry is configured to operate the system based on the captured images of the optical markers by operating the at least one speaker based on the captured images of the optical markers.

6. The system defined in claim 2 wherein the optical input accessory further comprises at least first and second light sources.

7. The system defined in claim 6 wherein the first light source is configured to emit a first type of light and wherein the second light source is configured to emit a second type of light that is different from the first type of light.

8. The system defined in claim 7 wherein the first type of light is light of a first frequency and wherein the second type of light is light of a second frequency that is different from the first frequency.

9. The system defined in claim 7 wherein the first type of light is intensity-modulated light that is modulated at a first modulation frequency and wherein the second type of light is intensity-modulated light that is modulated at a second modulation frequency that is different from the first modulation frequency.

10. The system defined in claim 6 wherein the imaging system is configured to respond to light from the first and second light sources and wherein the control circuitry is configured to generate position and orientation data for the accessory based on the response to the light from the first and second light sources.

11. The system defined in claim 2, further comprising communications circuitry.

12. A system, comprising:
an imaging system;
storage and processing circuitry; and
an optical input device having a plurality of light sources and a plurality of optical markers, wherein the imaging system is configured to capture images of the optical markers and the light sources on the optical input device and wherein the control circuitry is configured to operate the system based on the captured images of the optical markers and the light sources.

13. The system defined in claim 12, further comprising a display, wherein the control circuitry is configured to determine a position of the optical input device based on the captured images and to operate the system based on the captured images of the optical markers and the light sources by displaying a virtual object on the display in a position that corresponds to the determined position of the optical input device.

14. The system defined in claim 13 wherein the imaging system comprises at least one image sensor having an array of image pixels.

15. The system defined in claim 14 wherein the plurality of optical markers comprises visual representations of piano keys on a surface of the optical input device.

16. The system defined in claim 15 wherein the plurality of optical markers further comprises visual representations of guitar strings on a surface of the optical input device.

17. The system defined in claim 16, further comprising input-output devices, wherein the control circuitry is configured to operate the system based on the captured images of the optical markers and the light sources by determining motions and positions of a user input device with respect to the optical markers using the captured images.

18. A system, comprising:
a central processing unit;
memory;
input-output circuitry;
an imaging device; and
an optical input accessory, comprising:
optical markers on a surface of the optical input accessory, and
a plurality of light sources, each of which emits intensity-modulated light at a particular modulation frequency, wherein the imaging device is configured to capture images of at least the optical markers.

19. The system defined in claim 18 wherein the optical markers comprise visual representations of instrument components on a surface of the optical input device.

20. The system defined in claim 19 wherein the optical markers further comprise visual representations of buttons on a surface of the optical input device.
